(19) United States
(12) Patent Application Publication
(10) Pub. No.: US 2014/0052034 A1
(43) Pub. Date: Feb. 20, 2014

(54) PORTABLE MASSAGE CHAMBER

(71) Applicant: Sierra Healthstyles LLC, Tucson, AZ (US)

(72) Inventor: Simon MARXER, Oro Valley, AZ (US)

(73) Assignee: Sierra Healthstyles LLC, Tucson, AZ (US)

(21) Appl. No.: 13/968,012

(22) Filed: Aug. 15, 2013

Related U.S. Application Data
(60) Provisional application No. 61/684,017, filed on Aug. 16, 2012.

(51) Int. Cl. A61H 1/00

(52) U.S. Cl. CPC A61H 1/008
USPC 601/134

(57) ABSTRACT

A portable massage chamber for is provided. The portable massage chamber may include a plurality of support legs and a top frame coupled to an end of each of the legs. The top frame may be positioned above a floor surface and may include at least one support member. At least one attachment element may be moveably coupled to the at least one support member. At least one strand of fabric may be secured to the at least one attachment element. The strand of fabric may be a warp-knit fabric material.

### CROSS-REFERENCE TO RELATED APPLICATIONS

This application claims priority to U.S. Provisional Patent Application No. 61/684,017, filed Aug. 16, 2012, the contents of which are hereby incorporated herein by reference in its entirety.

### BACKGROUND

1. Field of Invention

The invention relates to a portable massage chamber.

2. Related Art

Chavutti Thirumal is a traditional Indian massage technique developed by Kalari Martial Artists of Kerala, India (Kalaripayattu). Typically, with a recipient positioned on the floor, the Chavutti Thirumal therapist holds onto a rope hanging or extending overhead and utilizes his/her feet to deliver treatment in long, sweeping therapeutic motions over the entire body of the recipient. Healing/therapeutic oils may be used.

What is needed is a low cost, easy-to-assemble portable structure or frame capable of supporting at least a portion of the bodyweight of a therapist for practicing foot massage techniques.

### SUMMARY

In accordance with an embodiment of the invention, a portable massage chamber is provided. The portable massage chamber may include a plurality of support legs and a top frame coupled to an end of each of the legs. The top frame may be positioned above a floor surface and may include at least one support member. At least one attachment element may be moveably coupled to the at least one support member. At least one strand of fabric may be secured to the at least one attachment element. The strand of fabric may be a polyester-lycra material.

In accordance with another embodiment of the invention, a method is provided. The method may include utilizing the portable massage chamber to perform a massage on a recipient positioned on the floor surface below the top frame. A massage therapist may grip the at least one strand of fabric to variably support at least a portion of the bodyweight of the massage therapist above the recipient to enable use of the feet of the massage therapist on the body of the recipient.

In accordance with another embodiment of the invention, a kit may be provided for assembling a portable massage chamber.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 is a schematic perspective view of a portable massage chamber according to an embodiment of the invention;

FIG. 2 is a schematic top view of the portable massage chamber depicted in FIG. 1; and

FIG. 3 is a schematic perspective view of a portable massage chamber according to an embodiment of the invention, including some example dimensions.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention.

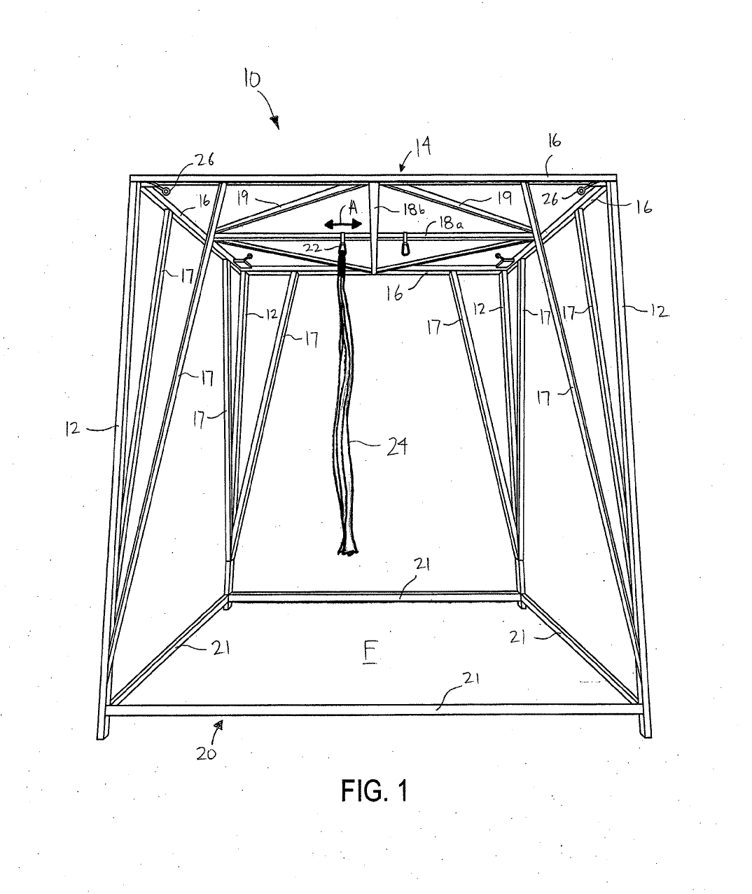

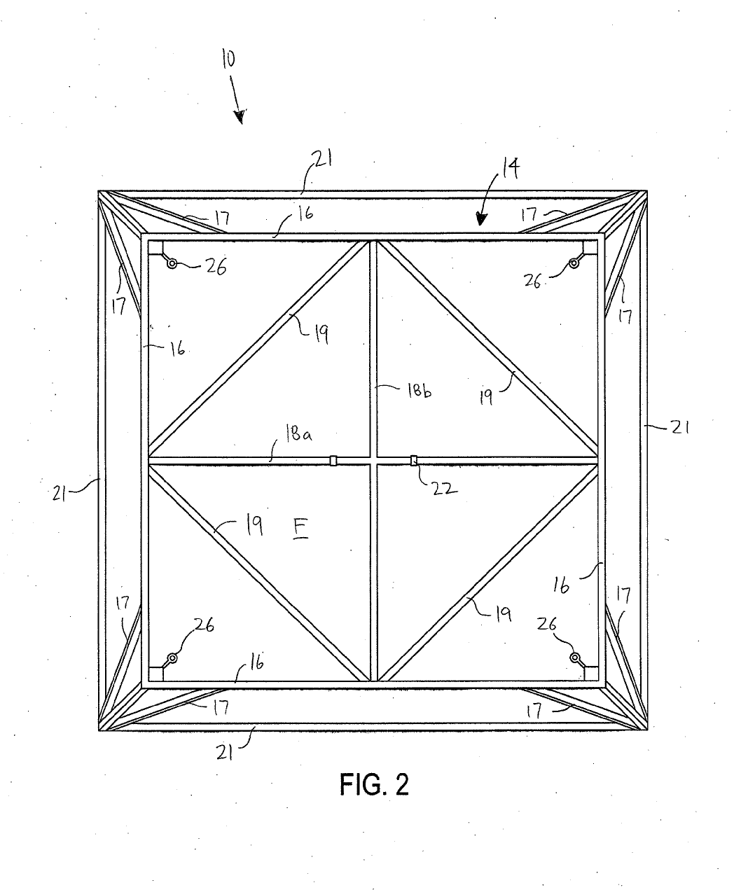

FIG. 1 is a schematic perspective view of a portable massage chamber (structure or frame) 10 according to an embodiment of the invention. FIG. 2 is a schematic top view of the portable massage chamber 10 shown in FIG. 1. As shown in FIGS. 1 and 2, the portable massage chamber 10 may include a plurality of support legs 12 and a top frame coupled to an end of each of the legs 12 and positioned above a floor surface F. The top frame 14 may include a plurality of elongated frame members 16 coupled together at their ends to define an outer frame. At least one cross member 18a, 18b may be provided as shown. One or more additional strengthening members 19 may also be included in the top frame 14 to structurally reinforce the top frame 14. One or more angled strengthening elements 17 may be provided between the legs 12 and respective frame members 16 to further stabilize and strengthen the chamber 10. A bottom frame 20 may also be provided including a plurality of elongated members 21 extending between and coupled to a bottom end of the legs 12 proximate floor surface F. Members 12, 16, 17, 18a, 18b, 19, and 21 may be, for example, metal tubing or angle bar (e.g., steel).

An attachment element 22 may be moveably coupled to the at least one cross member 18a, 18b so as to be movable along a longitudinal length thereof as shown by arrow A. A strand of fabric 24 may be secured to the attachment element 22 to allow a user such as, for example, a massage therapist to grip the fabric 24 and support at least a portion of his/her bodyweight above a massage recipient (not shown) positioned on the floor surface F. The attachment element 22 may be, for example, a ring element movably coupled on the cross member 18a, 18b. Alternatively, the cross member 18a, 18b could include a linear track or the like on or within which the attachment element 22 is movably received. The strand of fabric 24 may be any suitable material such as aerial tissue or any low- or medium-stretch warp-knitted fabric commonly utilized for aerial silks (e.g., polyester-lycra blend, tricot or the like). Additional fixed attachment elements 26 may also be provided on the top frame 14 as needed for attachment of additional strands of fabric 24 depending on the needs and techniques of the therapist.

A kit may be provided wherein the portable massage chamber 10 described above and shown in FIGS. 1 and 2 is provided in unassembled form. Fasteners such as, bolts, screws, nuts, washers, may be provided for coupling the individual elements together to form the portable massage chamber 10. Appendix A provides an example list of fasteners required for assembly of the portable massage chamber 10.

In use, a massage therapist (not shown) may utilize the portable massage chamber 10 shown in FIGS. 1 and 2 to perform a massage on a recipient (not shown) positioned on the floor surface F below the top frame 14. The massage therapist may grip the at least one strand of fabric 24 to variably support at least a portion of his/her bodyweight above the recipient to enable use of the massage therapist's feet on the body of the recipient.

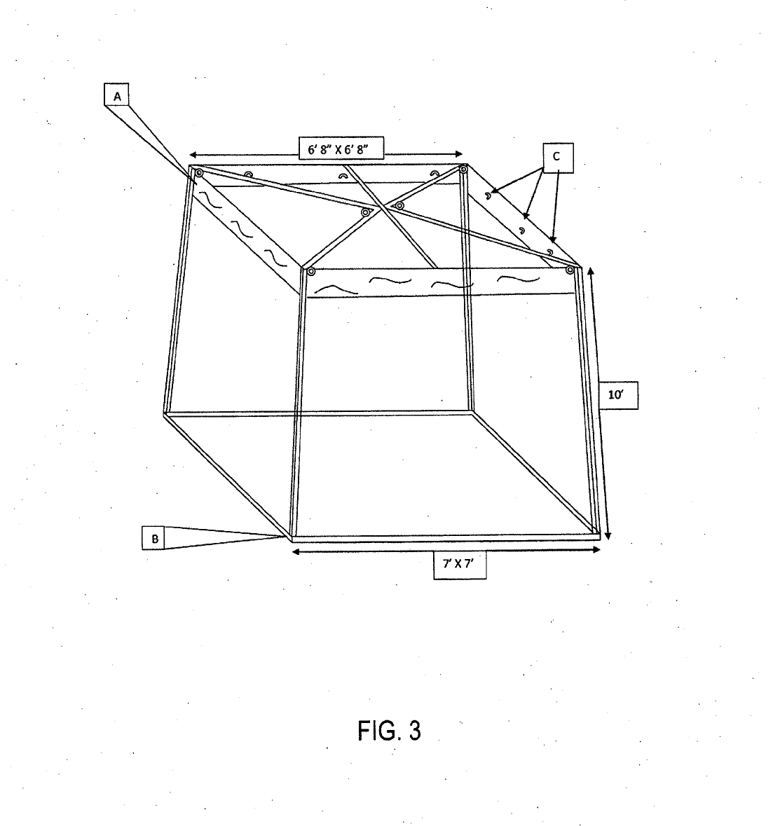

FIG. 3 is a schematic perspective view of a portable massage chamber according to an embodiment of the invention, including some example dimensions.

Example assembly instructions are attached as Appendix B.

While various embodiments of the present invention have been described herein, it should be understood that they have been presented by way of example only, and not limitation. Thus, the breadth and scope of the present invention should not be limited by any of the described embodiments, but should instead be defined only in accordance with the following claims and their equivalents.

I claim:

1. A portable massage chamber, comprising:
a plurality of support legs;
a top frame coupled to an end of each of the legs and positioned above a floor surface, wherein the top frame includes at least one cross member;
at least one attachment element moveably coupled to the at least one cross member; and
at least one strand of fabric secured to the at least one attachment element.

2. The portable massage chamber of claim 1, wherein the at least one attachment comprises a ring member attached to the at least one cross member and arranged to be moved along a longitudinal length of the at least one cross member.

3. The portable massage chamber of claim 1, further comprising a bottom frame coupled to another end of each of the legs proximate the floor surface.

4. The portable massage chamber of claim 1, further comprising at least one additional attachment element coupled to the top frame, wherein another strand of the at least one strand of fabric is secured to the at least one additional attachment element.

5. A method, comprising:
utilizing the portable massage chamber of claim 1 to perform a massage on a recipient positioned on the floor surface below the top frame, wherein a massage therapist grips the at least one strand of fabric to variably support at least a portion of the bodyweight of the massage therapist above the recipient to enable use of the feet of the massage therapist on the body of the recipient.

6. A portable massage chamber assembly kit, comprising:
a plurality of support legs;
a plurality of elongated frame members and at least one cross member configured to be coupled together to form a top frame, the top frame configured to be coupled to an end of each of the plurality of support legs;
at least one attachment element configured to be moveably coupled to the at least one support member; and
at least one strand of fabric configured to be secured to the at least one attachment element.

7. The assembly kit of claim 6, wherein the at least one attachment comprises a ring member configured to be attached to the at least one support member so as to be movable along a longitudinal length of the at least one support member.

8. The assembly kit of claim 6, further comprising a plurality of second cross members configured to be coupled together to form a bottom frame, the bottom frame configured to be coupled to another end of each of the plurality of support legs proximate the floor surface.

9. The assembly kit of claim 6, further comprising:
at least one additional attachment element configured to be coupled to the top frame; and
another strand of the at least one strand of fabric configured to be secured to the at least one additional attachment element.
